(19) United States
(12) Patent Application Publication
(10) Pub. No.: US 2016/0042444 A1
(43) Pub. Date: Feb. 11, 2016

(54) TRANSPORT EQUIPMENT LOGISTICS

(71) Applicants: Harald HENGELBROCK, Heidelberg (DE); Mark FINCH, Walnut Creek, CA (US); Irene CHEN, Shanghai (CN); Xingtian SHI, Shanghai (CN); Philippe NEMERY, Shanghai (CN); Terry WANG, Shanghai (CN)

(72) Inventors: Harald HENGELBROCK, Heidelberg (DE); Mark FINCH, Walnut Creek, CA (US); Irene CHEN, Shanghai (CN); Xingtian SHI, Shanghai (CN); Philippe NEMERY, Shanghai (CN); Terry WANG, Shanghai (CN)

(21) Appl. No.: 14/456,421

(22) Filed: Aug. 11, 2014

(51) Int. Cl. G06Q 30/06; G06Q 30/04

(52) U.S. Cl. CPC G06Q 30/0645; G06Q 30/0635; G06Q 30/04

(57) ABSTRACT

A computer-implemented method includes receiving, at a rental company, a customer's order to hire a transport equipment unit of a first type beginning on a start date. The rental company has an inventory of transport equipment units for hire and a network of diverse storage sites. The computer-implemented method further includes locating one or more transport equipment units of the first type in the rental company's inventory of transport equipment available for hire by the start date, computing the rental company's costs associated with picking up each of the located transport equipment units of the first type for delivery to the customer, and selecting, based on consideration of the rental company's picking up costs, one of the located transport equipment units for delivery to customer.

### BACKGROUND

Transport equipment is used to move material from one location to another (e.g., between workplaces, between a loading dock and a storage area, etc.) within a facility or from site to site. Customers use different types of transportation equipment (e.g., vacuum tank trucks, box truck, roll off truck, dump truck, flatbed and equipment trailers, refrigerated trucks, forklifts, cranes, containers, chassis, gen-sets, prime movers, etc.) to move different types of materials from one location to another.

A transportation equipment logistics or “rental” company (“Rental Company”) may be in the business of providing transport equipment for hire to customers for short term or long term use. The Rental Company may maintain an inventory of the different types of transportation equipment over a network of geographically-distributed storage sites or depots. The Rental Company may directly own the inventory of the different types of transportation equipment or may lease the inventory from other companies (e.g., from transport equipment manufacturers, leasing companies, banks, etc.). Leased equipment may have varying lease costs based, for example, on conditions such as time period, location, equipment type, etc. A Rental Company may supply a specific transportation equipment ordered or booked by a customer. The specific transportation equipment may be picked-up at the depot (“pick-up depot”) having the specific transportation equipment in its current inventory and returned to the same or other depot (“return depot”) in the Rental Company's network of depots.

Maximizing utilization of the Rental Company's inventory of transport equipment stored in the various depots requires consideration of time of hire, distance to the customer location, and the type of equipment required by the next customer. Often simplistic rules are manually applied to determine the pick-up depot from which the transport equipment should be picked-up for hire to a customer and the return depot to which the transport equipment should be returned after the end of the hire period. For example, an Equipment Control group in the Rental Company may periodically distribute a list or spreadsheet to a Customer Service group, with the spreadsheet listing sites or depots and the inventory of transport equipment types at each site or depot. However, the spreadsheet may not include real time information and may lack information on whether the transport equipment is actually available at a depot in condition for hire. Because of the lack of timely information on whether the transport equipment is actually available and in condition for hire, a depot may be overstocked or understocked to meet customer bookings The Rental Company may have to reposition inventory incurring additional transportation cost and delay.

Consideration is now being given to systems and methods for managing utilization of the Rental Company's inventory of transport equipment. Attention is directed to increasing efficiency and reducing costs.

### SUMMARY

A computer-implemented method for managing inventory of transport equipment rental company is described herein. The rental company may have an inventory of transport equipment units for hire and a network of diverse storage sites, each storage site having a capacity to stock a portion of the inventory of transport equipment units for hire. The diverse storage sites may have diverse gate and storage charges for the transport equipment units stored therein.

In one aspect, the computer-implemented method involves receiving a customer's order to hire a transport equipment unit of a first type beginning on a start date and locating one or more transport equipment units of the first type in the inventory of transport equipment available for hire by the start date.

In a further aspect, the computer-implemented method involves computing costs associated with picking up each of the located transport equipment units of the first type for delivery to the customer, and selecting, based on consideration of the picking up costs, one of the located transport equipment units for delivery to customer.

In second aspect, the computer-implemented method involves receiving a notification of an end-of-hire empty transport equipment unit of a first type present at a customer location.

In a further aspect the computer-implemented method involves computing the costs associated with returning the end-of hire empty transport equipment unit of the first type from the customer location to one or more of the diverse storage sites, and selecting, based on consideration of the costs, one of the diverse storage sites as a return location for receiving the end-of hire empty transport equipment unit from the customer location.

The details of one or more implementations are set forth in the accompanying drawings and the description below. Further features of the disclosed subject matter, its nature and various advantages will be more apparent from the accompanying drawings the following detailed description, and the claims.

### BRIEF DESCRIPTION OF THE DRAWINGS

FIG. 1 is a block diagram illustration of an example system for generating transportation equipment logistics recommendations for managing a Rental Company's inventory of transportation equipment inventory, in accordance with principles of the disclosure herein.

FIG. 2 is a schematic illustration of an example method for generating an equipment pick-up recommendation for satisfying a customer booking or order for a particular type of transport equipment from a particular storage site or depot, in accordance with principles of the disclosure herein.

FIG. 3 is a schematic illustration of an example method for generating an equipment return recommendation for the logistics of bringing empty equipment back from a customer location at the end of the customer booking or hire period, in accordance with principles of the disclosure herein.

### DETAILED DESCRIPTION

Systems and methods for generating recommendations for the logistics of transport equipment pick-up and return in the internal operations of a transportation equipment rental company, are described herein.

Existing enterprise business application systems (e.g., transportation management applications and event management applications) concern business aspects and transportation logistics (e.g., order intake, invoicing or ticketing, route optimization, transportation zone and schedule management, etc.) from the perspective of a customer utilizing the transportation services of a carrier company (e.g., a trucking company, railroad, shipping company, etc.) to ship goods or cargo from one place to another. The existing business application systems do not concern or provide solutions for the transportation logistics that may be needed in the internal operation of the carrier company to provide the shipping or transportation services to the customer.

The systems and methods described herein, which are computer-implemented, are configured to provide a logistics solution for management of an inventory of transport equipment (a Rental Company's inventory of transport equipment such as trucks, trailers, containers, etc.) between points of origin or pick-up (e.g., Rental Company storages sites or depots), points of delivery or consumption (e.g., customer task or work sites, etc.), and points of return (e.g., Rental Company storages sites or depots), in accordance with the principles of the present disclosure. The systems and methods may integrate real-time or near real-time information on the location and condition of transport equipment and transactional market data (e.g., customer bookings for specific transport equipment, purchase orders, freight orders, transportation requests, etc.) with cost models (equipment capital or lease cost models, equipment storage cost models, etc.) and equipment selection rules (e.g., equipment substitution rules) to generate a recommendation for pick-up and return of a specific transport equipment for a transaction (e.g., a customer booking) The recommendation, which may include of identification of pick-up and return locations and times, may be dynamic in that a designated return location for the transport equipment on hire may be changed after the pick-up event.

Further, for convenience in description herein, the following terminology may be adopted herein:
Transportation Equipment—: transportation equipment or resources (e.g., containers, trucks, prime movers, trailers, etc.). The transportation equipment may be an asset of the Rental Company, which may rent or hire out the transportation equipment to a customer. The transportation equipment may be rented or hired out in an empty condition to the customer who may use the transportation equipment for material moving tasks (e.g., at a customer site or location).
   For convenience in description herein, singular transport equipment (e.g., a truck) may be referred to as “a transportation equipment unit” and plural transport equipment (e.g., trucks) may be referred to as “transportation equipment units.”
Cargo—: material (e.g., commodities, chemicals, foods, building materials, livestock, industrial goods, packages, etc.) moved using the transportation equipment (e.g., by the customers who may hire the transportation equipment).
Equipment Supply Zone, Storage sites, Depots: storage site or depot where empty transportation equipment is kept and maintained by the Rental Company for hire by customers. Empty transportation equipment may be made available for pick-up (e.g., for delivery to a customer) from and returned to the Equipment Supply Zone at the end of a rental or hire period. The equipment may be moved or driven between the Equipment Supply Zone and the customer location by drivers who may, for example, be employees or agents of the Rental Company.
Customer Location: the work site address to which the customer will take the equipment to or the address at which the customer will accept delivery of the equipment.
Street-Turn: empty equipment which as it is being moved to a designated return location (e.g., at the end of a hire or rental period by a first customer) can be redirected to another customer location to satisfy a booking by the other customer. Street-turn opportunities may be determined by consideration of whether the equipment can reach the other pick-up location in time to satisfy the booking by the next customer.
One-way: equipment that is to be picked up only for an outbound journey and is not returned to the Rental Company. One-way equipment may, for example, be end-of-lease equipment that about to be returned to the lessor by the Rental Company or equipment which is intended to be transferred to a third party at the end of the outbound journey.
Events: an equipment pick-up event is a pick-up and delivery of a specific transport equipment to a customer location from a Rental Company storage site or depot. An equipment return event is the return to a Rental Company storage site or depot (or other disposal) of the specific transport equipment from the customer location at the end of a hire period. The pick-up and return events may occur in response to or in the course of fulfilling customer bookings, orders or requests for transportation equipment. The events may include processes and preparation that the Rental Company may have to undertake to have the equipment ready in condition for hire at a storage site or depot designated for pick-up. For example, the pick-up event may include moving or repositioning the equipment to the designated storage site from another storage site, or repairing or cleaning the equipment if already at the designated storage site. Description of the events may include transaction or logistics data (e.g., storage sites, customer locations, distances and times involved, equipment types, street-turn or one way identifications, equipment condition, etc.).

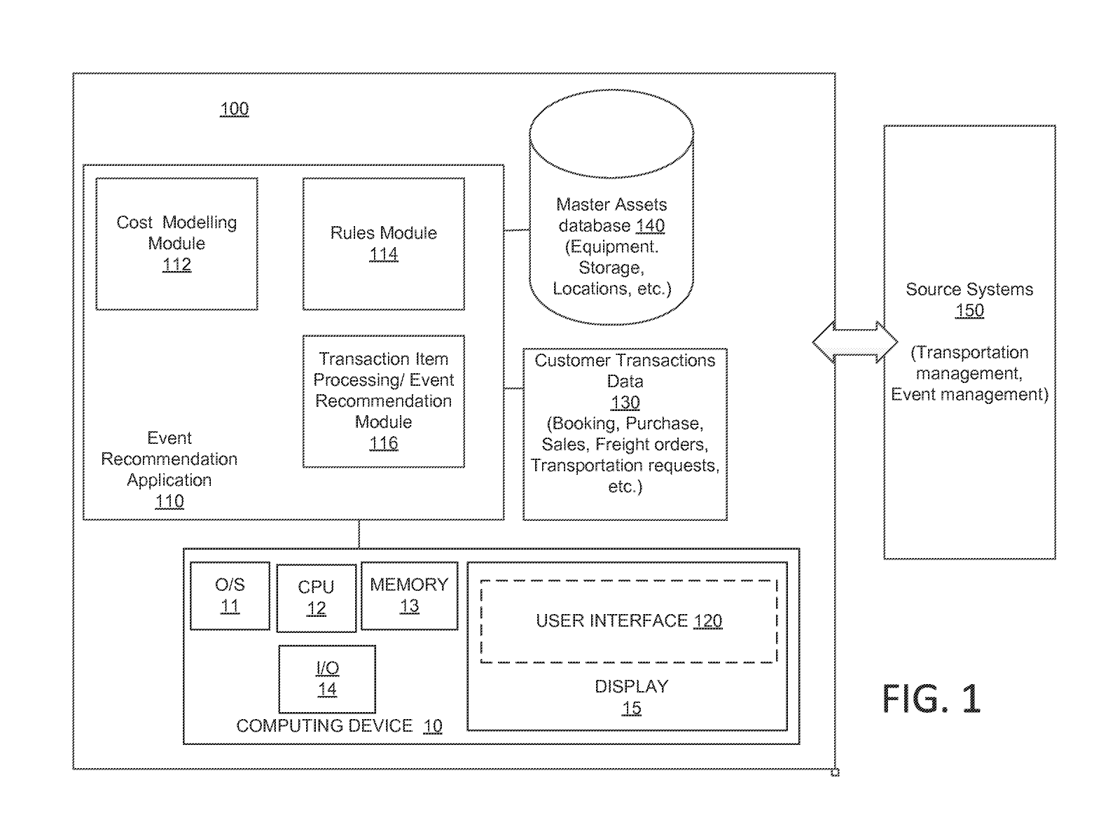

FIG. 1 shows an example system 100 for generating equipment logistics recommendations for managing the Rental Company's inventory of transportation equipment inventory, in accordance with principles of the disclosure herein. The equipment logistics recommendations may include, in one aspect, a recommendation for the conduct of or preparation for an equipment pick-up event and, in a second aspect, a recommendation for the conduct of or preparation for an equipment return event.

System 100 may include or be coupled to a master assets database 140, which may include information on the Rental Company's inventory of transportation equipment and network of storage sites and depots (e.g. information of equipment types and other characteristics, storage site capacity, location and other characteristics, etc.). System 100 may further include an Event recommendation application 110, which may be configured to use the information in Master assets database 140 to generate an equipment logistics recommendation in response to customer demand (e.g., a booking or order) for particular transportation equipment for hire.

System 100 may also include or be coupled to a store of Customer transactions data 130, which may include transactional items such as booking orders, purchase orders, sales orders, freight orders, transportation requests, etc., which the Rental Company may receive from customers. The transactional items may include information on the equipment type or types requested, the requested periods of hire, customer locations, types of cargo to be moved, etc. Enterprise business application systems (e.g., Source systems 150) may be used by the Rental Company to interface with customers regarding customer demand (e.g., a booking or order) for transportation equipment for hire. The enterprise business application systems (e.g., Source systems 150), which may include transportation management and event management applications, may be coupled to system 100 and may be the source of the transactional items (such as booking orders, purchase orders, sales orders, freight orders, transportation requests, etc.) in the store of Customer transactions data 130. The transportation management and event management applications in Source systems 150 may receive real-time or near real-time information on the location and condition of transportation equipment in transit or at storage sites or depots (e.g., via communication channels such as web and mobile user interfaces, e-mail, SMS, B2B, GPS, etc.). Source systems 150 may update Master assets database 140 in system 100 or otherwise provide the real-time or near real-time information on the location and condition of transportation equipment in transit or at storage sites or depots to Event recommendation application 110 in system 100.

Event recommendation application 110, may be configured to process the transactional items (such as booking orders, purchase orders, sales orders, freight orders, transportation requests, etc.) in the store of Customer transactions data 130 one-by-one or in groups. A Transactional item processing/Event recommendation module 116 in Event recommendation application 110 may be configured to use information in Master assets database 140 to generate an equipment logistics recommendation for each transactional item in the store of Customer transactions data 130. The equipment logistics recommendation for each transactional item (e.g. a booking for a particular transport equipment) may include, in one aspect, a recommendation for the conduct of an equipment pick-up event and, in a second aspect, a recommendation for the conduct of an equipment return event. The equipment logistics recommendation for each transaction item may include recommendations for selection of equipment type, equipment pick-up locations and times, and equipment return locations and times, etc. The recommendations may include identification of street-turn opportunities and one-ways.

The recommendations generated by Transactional item processing/Event recommendation module 116 may be designed to reduce the Rental Company's costs and to increase utilization of the Rental Company's inventory of transportation equipment.

For this purpose, Transactional item processing/Event recommendation module 116 may be coupled to a Cost modelling module 112 and a Rules module 114 in event recommendation application 110. Cost modelling module 114 may include an equipment cost model and an equipment storage cost model applicable to the Rental Company's inventory of transportation equipment and network of storage sites and depots (e.g., Master assets database 140). Rules Module 116 may include rules (e.g., commodity-based rules and equipment-substitution rules, etc.) that may apply to selection of transportation equipment type to satisfy a transaction item. A commodity-based rule in rules module 116 may limit the equipment types that can be selected to satisfy a transaction item. For example, a commodity-based rule may require that only a refrigerated truck may be selected to satisfy a transaction item involving transportation of milk. An equipment substitution rule in Rules module 116 may allow substitution of one equipment type by another in defined circumstances. Event recommendation application 110 may use the equipment substitution rule to map the Rental Company's different equipment types to allowable substitute equipment types. The mapping, for a particular type of transport equipment in a transaction item, to allowable substitute equipment types may involve consideration of the cargo or commodity to be moved, equipment location, and equipment type, sub-type and size. For example, events recommendation application 110 may determine that a 2-ton closed truck is an allowable substitute for a customer booking requesting a 1-ton open truck to move dry cargo. Transaction item processing/Event recommendation module 116 may be configured to process the transactional items in the store of Customer transactions data 130 in conjunction with Cost modelling module 112 and Rules module 114 to generate equipment pick-up and return event recommendations, which may be designed to reduce the Rental Company's costs and increase utilization of the Rental Company's inventory of transportation equipment.

In system 100, Event recommendation application 110 and other system components (e.g., store of Customer transactions data 130, Master assets database 140) may be hosted on one or more standalone or networked physical or virtual computing machines. FIG. 1 shows, for example, Event recommendation application 110 hosted on a computing device 10 (e.g., a desktop computer, a mainframe computer, a personal computer, a mobile computing device, a laptop, a tablet, or a smart phone), which may be available to a user. Computing device 10, which includes an O/S 11, a CPU 12, a memory 13, and I/O 14, may further include or be coupled to a display 15 (including, for example, a user interface 120). Event recommendations generated by event recommendation application 110 may be presented to a user, for example, on user interface 120.

Moreover, although computer 10 is illustrated in the example of FIG. 1 as a single computer, it may be understood that computer 10 may represent two or more computers in communication with one another. Therefore, it will also be appreciated that any two or more components of system 100 may similarly be executed using some or all of the two or more computing devices in communication with one another. Conversely, it also may be appreciated that various components illustrated as being external to computer 10 may actually be implemented therewith.

Event recommendation application 110 may be linked, for example, via Internet or intranet connections, to Master asset data base 140 and Source systems 150. Further, Event recommendation application 110 may be linked to data sources on the web (e.g., worldwide and/or enterprise webs) and/or or other computer systems of the organization (e.g., e-mail systems, human resources systems, material systems, operations, etc.) (not shown) that may have information relevant to the generation and implementation of the equipment pick-up event and equipment return recommendations generated by Event recommendation application 110.

### Equipment Pick-Up Recommendation

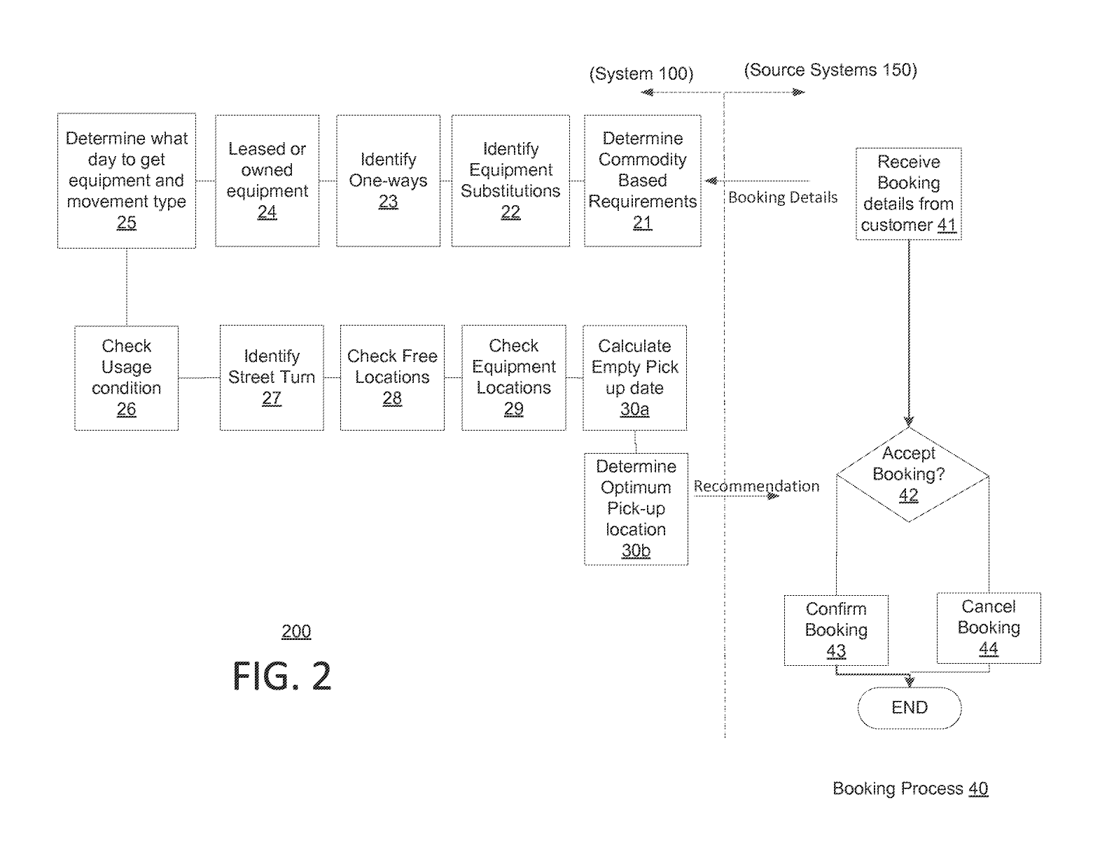

FIG. 2 shows an example method 200 for generating an equipment pick-up recommendation for satisfying a customer booking or order for a particular type of transport equipment from a particular storage site or depot. Method 200 may, for example, be implemented using Events recommendation application in system 100 in conjunction with an equipment booking process 40 on Source system 150.

Booking process 40 may, for example, include receiving an equipment booking order from a customer (41). The booking order may include details such as the type of equipment, the date or time of hire, and the type of cargo that the customer expects to move with the equipment, etc. Booking process 40 may revert to system 100 for an equipment pick-up recommendation for satisfying the customer booking. Based on the equipment pick-up recommendation, process 40 may involve a decision on whether to accept or not accept the booking order (42) and accordingly confirming the booking (43) or cancelling the booking (44).

Method 200 may involve identifying “candidate” equipment which can be picked up to satisfy the customer booking Identifying the candidate equipment may involve identifying which equipment should be picked up and also the storage site or depot from where the equipment should be picked up to satisfy the customer booking Events recommendation application 110 in system 100 may be configured to initiate implementation of method 200 when details of the customer booking are received (e.g., as a transactional item in the store of Customer transactions data 130, FIG. 1) from booking process 40.

Toward identifying candidate equipment and storage sites or depots for satisfying the customer booking, method 200 may include determining if any cargo or commodity-based rules apply to the customer booking (21) and identifying possible equipment substitutions that may be used to satisfy the customer booking (22). Events recommendation application 110 may be configured to review commodity and equipment substitution rules (Rules module 114) to determine if there are any specific equipment type or preparation requirements needed to satisfy the customer booking for the particular type of transport equipment from a particular storage site or depot. Further, Events recommendation application 110 may use equipment substitution rules (Rules module 114) to determine if substitute equipment types can be used to satisfy the customer booking for the particular type of transport equipment.

Method 200 may further involve identifying one-ways that may be used to reduce surplus inventory a storage site (23) and determining whether the equipment is leased or owned by the Rental Company (24). Toward identifying candidate equipment to satisfy the customer booking and yet reducing Rental Company costs, Event recommendation application 110 may run lease cost models (e.g., Cost modelling module 112) to determine the carrying costs associated with the equipment and select the equipment with the least cost as the candidate equipment to satisfy the customer booking

Method 200 may also involve determining by which day or time the Rental Company should get the candidate equipment ready at a storage depot to satisfy the customer booking (25) and determining a usage condition of the candidate equipment to ensure that the equipment is in (or can be timely restored to) a condition fit to satisfy the customer booking (26). Method 200 may further involve identifying street turn opportunities as possible candidate equipment (27).

In a further aspect, after the candidate equipment has been identified, method 200 involves determining an optimum pick-up date (30a) and an optimum pick-up location or storage site (30b). For this purpose, method 200 may involve may identifying free storage sites or depots (i.e. sites that do not have gate charges for moving equipment in or out, and do not have equipment storage charges) (28), and checking gate and storage charges at other equipment locations that have the candidate equipment in inventory (29). Toward determining the optimum pick-up date and the optimum pick-up location or storage site, event recommendation application 110 may run storage cost models (e.g., Cost modelling module 112) to determine storage site costs and select storage sites with the least costs as potential storage sites for equipment pick-up to satisfy the customer booking Event recommendation application 110 may further give consideration to the distance and equipment delivery costs from the storage sites to the customer location in determining an optimum pick-up location or storage site.

The equipment pick-up recommendation generated by method 200 in the foregoing manner may include identification of the candidate equipment and the optimum storage site for equipment pick-up to satisfy the customer booking The equipment pick-up recommendation may be used in process 40 in system 150 to decide whether to accept or cancel the customer booking

Method 200/Event recommendation application 110 have been described in the foregoing as generating an equipment pick-up recommendation including identification of a single candidate equipment and a single optimum storage site for equipment pick-up. However, it will be understood that method 200/Event recommendation application 110 may be readily modified or extended to generate an equipment pick-up recommendation, which includes several optional candidate equipment, pick-up dates, and storage sites for equipment pick-up. Further, method 200/Event recommendation application 110 may include estimates of the costs (e.g., equipment lease costs, gate and storage charges, etc.) that may be incurred by the Rental Company in executing the equipment pick-up recommendation. TABLE 1 shows an example equipment pick-up recommendation with different options (e.g., Option No. 1 and Option No. 2) for equipment pick-up to satisfy a customer order. Each option in the pick-up recommendation (which may be generated by method 200/event recommendation application 110) includes a description of equipment type, location, pick-up date and cost.

TABLE 1

| Option | Equipment | Equipment | | Pick-up | |
|---|---|---|---|---|---|
| No. | Type | ID | Location | Date | Cost |
| 1 | General | 297 | PORT_NEWARK | Oct., 21th | 20$ |
| | Tank | | | 2014 | |
| 2 | Pressure | 299 | Massachusetts | Oct., 25th | 50$ |
| | Tank | | | 2014 | |

### Equipment Return Recommendation

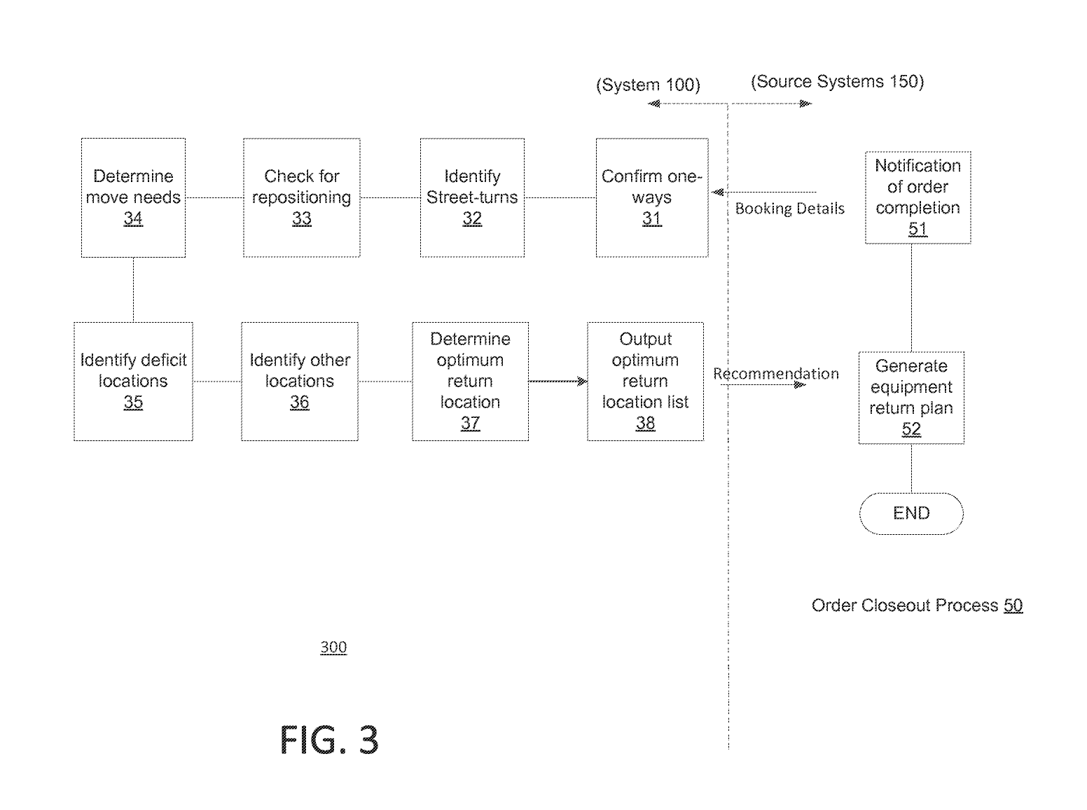

FIG. 3 shows an example method 300 for generating an equipment return recommendation for the logistics of bringing “end-of-hire” empty equipment back from a customer location at the end of the customer booking or hire period, in accordance with the principles of the disclosure herein. Method 300 may, for example, be implemented using Events recommendation application in system 100 in conjunction with a booking or order closeout process 50 on source system 150.

Order closeout process 51 may, for example, include receiving notification of completion of an equipment order at a customer location (41). The notification may include order details such as the type of equipment, the end date or end time of hire, and the type of cargo that was moved using the equipment, etc. Order closeout process 51 may revert to system 100 for an equipment return recommendation on the logistics of bringing the end-of-hire empty equipment back from the customer location to the Rental Company's storage sites or depots. Based on the equipment return recommendation, process 51 may generate an equipment return plan.

Method 300 may involve identifying storage sites or depots to which the end-of-hire empty equipment should be returned with a view of reducing the Rental Company's transportation and storage costs and reducing a turnaround time for making the returned equipment available for a next booking order or hire. Event recommendation application 110 in system 100 may be configured to initiate implementation of method 300, for example, when details of the customer booking are received (e.g., as a transactional item in the store of Customer transactions data 130, FIG. 1) from booking process 40 (FIG. 2) or from order closeout process 51.

Toward identifying candidate storage sites or depots for return of the end-of-hire empty equipment, method 300 may include determining if the end-of-hire empty equipment at the customer location was a one-way hire (31). If the equipment was a one-way hire, then the equipment should be transferred to the location (or to the third party recipient) that was identified at the time of the one-way booking, unless the basis for the one-way had since changed. Event recommendation application 110 in system 100 may confirm (from details of the customer booking and real-time information from source system 150) that the lease terms for transfer of the one-way are still valid and in force. If the lease terms dictate that the one-way equipment is not eligible for immediate transfer but soon will become eligible, Event recommendation application 110 may determine a low cost storage site near to the transfer location as a candidate storage site to hold the one-way equipment temporarily until it becomes eligible for transfer. If the lease terms for transfer of the one-way are no longer valid, the equipment may have to be returned to the Rental Company. Event recommendation application 110 may find a candidate storage site for the equipment in the same manner as for other end-of-hire empty equipment by further implementation of method 300 described below.

Method 300 may further include determining if the end-of-hire empty equipment is a street-turn candidate (32). Event recommendation application 110 in system 100 may review transportation that may already have been scheduled (e.g., by Source systems 150) to move the end-of-hire empty equipment within the Equipment Supply Zone on the end-of-hire date and confirm that the equipment has not been reserved for another booking or purpose. Event recommendation application 110 may further determine (e.g., by analysis of Master assets database 130 and Customer transactions data 140) if the end-of-hire empty equipment can be rerouted in transit or moved directly to another customer location in time to satisfy another booking order Customer transactions data 140). Using a street turn to satisfy the other booking order may save the Rental Company, at least nominally, the gate charges associated with bringing the empty equipment in and out of a storage site. Using the street turn may also reduce transportation or moving costs because moving the equipment directly between the end-of-hire customer location and the other customer location avoids the transportation cost of a detour through a storage site.

With further view of possible use of the end-of-hire empty equipment for the satisfying other booking orders, method 300 may include checking if the end-of-hire empty equipment is a candidate for repositioning (e.g., by analysis of Master assets database 130) (33). Event recommendation application 110 in system 100 may be configured to review planned equipment repositioning within the Rental Company's network of storage sites and depots. If there is any planned repositioning of equipment of the same type as the end-of-hire empty equipment, Event recommendation application 110 may select a storage site that needs the equipment type as the return storage site for the end-of-hire empty equipment. If the storage site that needs the equipment type is distant (e.g., in a different supply zone), Event recommendation application 110 may select a storage site enroute to the different supply zone as the return storage site for the end-of-hire empty equipment.

Method 300 may also include checking if there is any need to move the end-of-hire empty equipment from its current location (34). If the end-of-hire empty equipment can be left at its current location for at least a period of time, then moving costs and storage costs can be avoided for at least the period of time.

Further aspects of method 300 may relate to identifying candidate storage sites in the Rental Company's network of storage sites and depots as the return storage sites for the end-of-hire empty equipment. Method 300 may involve identifying storage sites that have a low inventory or a deficit of the equipment of the same type as the end-of-hire empty equipment (35). Event recommendation application 110 in system 100 may be configured to review storage site inventory data (e.g., Master assets database 130) to identify storage sites that can accept equipment of the same type as the end-of-hire empty equipment and identify which these storage sites having current inventory levels below their inventory management settings. Event recommendation application 110 may identify these storage sites as needing equipment replenishment to restore inventory levels and designate these storage sites as candidate return storage sites for the end-of-hire empty equipment. Returning the end-of-hire empty equipment to an inventory-deficit storage site may help the Rental Company reduce costs associated with otherwise having to reposition assets to restore or balance inventory levels across the network of storage sites.

Method 300 may further involve identifying storage sites, which even if they do not have a low inventory or a deficit of the equipment of the same type as the end-of-hire empty equipment, have open or excess storage capacity available to accommodate the end-of-hire empty equipment. Event recommendation application 110 may identify these storage sites that have open or excess storage capacity as candidate return storage sites for the end-of-hire empty equipment.

Method 300 may further involve selecting one or more of the candidate returns storage sites as optimum return locations for the end-of-hire empty equipment (37) and outputting a list of the optimum return sites (38), for example, to process 50. Event recommendation application 110 may select one or more of the candidate return storage sites as the optimum return locations for the end-of-hire empty equipment, for example, by running storage cost models (e.g., Cost modelling module 112) and also taking into consideration the distances and transportation costs from the customer location to the storage sites.

The various systems and techniques described herein may be implemented in digital electronic circuitry, or in computer hardware, firmware, software, or in combinations of them. The various techniques may implemented as a computer program product, i.e., a computer program tangibly embodied in a machine readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a standalone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magnetooptical disks, or optical disks. Information carriers suitable for embodying computer program instructions and data include all forms of nonvolatile memory, including by way of example semiconductor memory devices, e.g., EPROM, EEPROM, and flash memory devices; magnetic disks, e.g., internal hard disks or removable disks; magnetooptical disks; and CDROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a backend component, e.g., as a data server, or that includes a middleware component, e.g., an application server, or that includes a frontend component, e.g., a client computer having a graphical user interface or a Web browser through which a user can interact with an implementation, or any combination of such backend, middleware, or frontend components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer-implemented method for managing inventory of a transport equipment rental company, the rental company having an inventory of transport equipment units for hire and a network of diverse storage sites, each storage site having a capacity to stock a portion of the inventory of transport equipment units for hire, the diverse storage sites having diverse gate and storage charges for the transport equipment units stored therein, the computer-implemented method comprising:
receiving a customer's order to hire a transport equipment unit of a first type beginning on a start date;
locating one or more transport equipment units of the first type in the inventory of transport equipment available for hire by the start date;
computing costs associated with picking up each of the located transport equipment units of the first type for delivery to the customer; and
selecting, based on consideration of the picking up costs, one of the located transport equipment units for delivery to customer.

2. The method of claim 1, wherein locating one or more transport equipment units of the first type includes identifying a storage site having a transport equipment unit of the first type in stock, and wherein computing the costs associated with picking up each of the located transport equipment units includes considering the gate charges and storage charges for the storage site having a transport equipment unit of the first type in stock.

3. The method of claim 1, wherein the transport equipment units of the first type include leased units, and wherein computing the costs associated with picking up each of the located transport equipment units includes considering leasing costs for the leased units.

4. The method of claim 1, wherein computing the costs associated with picking up each of the located transport equipment units includes considering distances between each of the located transport equipment units and a customer location and considering transportations costs for delivering each of the located transport equipment units and the customer location.

5. The method of claim 1, wherein locating one or more transport equipment units of the first type in the inventory of transport equipment available for hire by the start date includes identifying an end-of-hire transport equipment unit located at a different customer location and due to be returned to a return storage site.

6. The method of claim 5, wherein selecting one of the located transport equipment units for delivery to customer includes selecting the end-of-hire transport equipment unit located at the different customer location for direct delivery to customer bypassing the return storage site.

7. The method of claim 1, wherein locating one or more transport equipment units of the first type in the inventory of transport equipment available for hire by the start date includes:
considering a commodity to be carried by the customer in the transport equipment units of the first type; and
substituting the one or more transport equipment units of the first type with one or more transport equipment units of a second type according to a commodity-based substitution rule.

8. The method of claim 1 further comprising reviewing the customer's order to hire the transport equipment unit of the first type is for a one-way hire, and wherein selecting one of the located transport equipment units for delivery to customer includes selecting a transportation unit from a storage site that has a surplus inventory of transport equipment units of the first type.

9. A computer-implemented method for managing inventory of a transport equipment rental company, the rental company having an inventory of transport equipment units for hire and a network of diverse storage sites, each storage site having a capacity to stock a portion of the inventory of transport equipment units for hire, the diverse storage sites having diverse gate and storage charges for the transport equipment units stored therein, the computer-implemented method comprising:
receiving a notification of an end-of-hire empty transport equipment unit of a first type present at a customer location;
computing the costs associated with returning the end-of hire empty transport equipment unit of the first type from the customer location to one or more of the diverse storage sites; and
selecting, based on consideration of the costs, one of the diverse storage sites as a return location for receiving the end-of hire empty transport equipment unit from the customer location.

10. The method of claim 9, wherein computing the costs associated with returning the end-of-hire empty transport equipment unit from the customer location to one or more of the diverse storage sites includes considering the gate charges and storage charges for receiving the end-of-hire empty transport equipment unit.

11. The method of claim 9, wherein computing the costs associated with returning the end-of-hire empty transport equipment unit from the customer location to one or more of the diverse storage sites includes determining which storage sites have an inventory deficit of transport equipment units of the first type, and wherein selecting one of the diverse storage sites as a return location for receiving the end-of-hire empty transport equipment unit from the customer location includes selecting one of the storage sites having an inventory deficit of transport equipment units of the first type as the return location.

12. A computer system for managing inventory of a transport equipment rental company, the rental company having an inventory of transport equipment units for hire and a network of diverse storage sites, each storage site having a capacity to stock a portion of the inventory of transport equipment units for hire, the diverse storage sites having diverse gate and storage charges for the transport equipment units stored therein, the computer system comprising:
a memory; and
a processor configured to run an events recommendation application which includes a cost modelling module and a rules module,
wherein the events recommendation application is configured to:
receive data regarding a customer's order to hire a transport equipment unit of a first type beginning on a start date;
locate one or more transport equipment units of the first type in the inventory of transport equipment units that are available for hire by the start date;
compute costs associated with picking up each of the located transport equipment units of the first type for delivery to the customer; and
select, based on consideration of picking up costs, one of the located transport equipment units for delivery to customer.

13. The computer system of claim 12, wherein the events recommendation application is configured to:
identify a storage site having a transport equipment unit of the first type in stock; and
compute the costs by considering the gate charges and storage charges for the storage site having a transport equipment unit of the first type in stock.

14. The computer system of claim 12, wherein the transport equipment units of the first type include leased units, and wherein the events recommendation application is configured to compute the costs associated with picking up each of the located transport equipment units by considering the leasing costs for the leased units.

15. The computer system of claim 12, wherein the events recommendation application is configured to compute the costs associated with picking up each of the located transport equipment units by considering distances between each of the located transport equipment units and a customer location and considering transportation costs for delivering each of the located transport equipment units and the customer location.

16. The computer system of claim 12, wherein the events recommendation application is configured to identify an end-of-hire transport equipment unit located at a different customer location and due to be returned to a return storage site.

17. The computer system of claim 16, wherein the events recommendation application is configured to select one of the located transport equipment units for delivery to customer by selecting the end-of-hire transport equipment unit located at the different customer location for direct delivery to customer bypassing the return storage site.

18. The computer system of claim 12, wherein the events recommendation application is configured to:
consider a commodity to be carried by the customer in the transport equipment units of the first type; and
substitute the one or more transport equipment units of the first type with one or more transport equipment units of a second type according to a commodity-based substitution rule.

19. The computer system of claim 12, wherein the events recommendation application is configured to determine if the customer's order to hire the transport equipment unit of the first type is for a one-way hire, and select a transportation unit from a storage site that has a surplus inventory of transport equipment units of the first type for delivery to the customer.

20. The computer system of claim 12, wherein the events recommendation application is configured to:
receive a notification of an end-of-hire empty transport equipment unit of a first type present at a customer location;
compute costs associated with returning the end-of hire empty transport equipment unit of the first type from the customer location to one or more of the diverse storage sites; and
select, based on consideration of costs, one of the diverse storage sites as a return location for receiving the end-of hire empty transport equipment unit from the customer location.
